(19) United States
(12) Patent Application Publication
(10) Pub. No.: US 2019/0343338 A1
(43) Pub. Date: Nov. 14, 2019

(54) Chop and Catch Device

(71) Applicant: Daniel Alan Campbell, Buckeye, AZ (US)

(72) Inventor: Daniel Alan Campbell, Buckeye, AZ (US)

(21) Appl. No.: 15/974,373

(22) Filed: May 8, 2018

(51) Int. Cl. A47J 47/00

(52) U.S. Cl. CPC A47J 47/005; B65D 1/34

(57) ABSTRACT

A chop and catch apparatus comprising a base comprising a base lower member and a base frame member surrounding and bounding base lower member and extending vertically upward therefrom forming an uncovered internal cavity; a support member comprising a spine and a plurality of support member arms, each attached to the spine, such support member freely removable from the base and positioned in the cavity of the base during use; a plurality of trays, each tray freely removable from the base, wherein the plurality of trays are positioned in the cavity of the base during use and at least one tray is positioned on one side of the support member and at least one tray is positioned on the opposite side of the support member; and a cutting board comprising a cutting board center member and a plurality of cutting board arms extending from cutting board center member, such cutting board being removably secured to the base and positioned above the cavity of the base, the plurality of trays, and the support member during such use.

### FIELD OF THE INVENTION

The present invention relates to a chop and catch apparatus for use in a domestic setting to chop, cut, segregate, and otherwise manipulate and compartmentalize multiple objects.

### BACKGROUND OF THE INVENTION

During many domestic chores, such as cooking, multiple items are required to be used. In many kitchen recipes, multiple ingredients are used, with most, if not all, ingredients chopped, cut, diced, minced, or otherwise manipulated before incorporation with other ingredients. Moreover, many ingredients are combined together in a specific order or in groups of combined ingredients (i.e., group one of combined ingredients comprising two or more ingredients that have each been chopped, cut, diced, minced, or otherwise manipulated is then combined with group two of combined ingredients two or more ingredients other than those ingredients in group one and that have each been chopped, cut, diced, minced, or otherwise manipulated). Such operations require many different receptacles for collecting cut, chopped, diced, minced, or otherwise manipulated ingredients individually (i.e., segregated collection). Having many different receptacles in turn takes up a larger portion of kitchen surface area (i.e., surface area of counters, tables, or other flat structures in a kitchen) where often times the preparer does not have adequate space, leave little remaining kitchen surface area for other kitchen operations, or insufficient space to even accommodate the plurality of receptacles.

In addition, the cutting, chopping, dicing, mincing, or otherwise manipulating of ingredients requires a relatively flat preparation surface separate and apart from the receptacles that, in turn, hold the resulting cut, chopped, diced, minced, or otherwise manipulated ingredients. The preparation surface further compounds the problem of limited kitchen surface area, with many kitchens constrained in space or lacking in space to accommodate the preparation surface, the receptacles, and other implements used in the kitchen for food preparation and storage. Moreover, with the process of ingredient preparation comprising first the chopping/manipulation of ingredients followed by their catching or segregated storing, the preparer has to dedicate a portion of the overall food preparation time for moving the each of the one or more cut, chopped, diced, minced, or otherwise manipulated ingredients from the preparation surface to their respective storage receptacles in order to “catch” or segregatedly store such ingredients, delaying or prolonging the overall food preparation time beyond what is really needed in order to finish preparing the dish that is the subject of the target recipe. In the busy world of today, most casual preparers of food either do not have much time to dedicate to food preparation, reducing the amount of available time to set aside for overall food preparation time, while professional preparers of food need to maximize the amount of time spent in actually preparing food (i.e., active cooking) and minimize “down” time or unproductive time associated with ingredient movement and manipulation in order to improve efficiency and cost-effectiveness, being able to do more in less time.

As such, there is a need in the art for a cut and catch apparatus for use in domestic settings such as in the kitchen during food preparation that is compact and space-efficient that provides a preparation surface and manipulated ingredient segregated storage receptacles in a configuration that reduces the amount of down time in the kitchen associated with simply moving around manipulated ingredients and getting them ready for eventual cooking so that a food preparer, facing the challenges of limited kitchen space and/or food preparation time, is able to overcome such challenges in an efficient and effective manner.

### SUMMARY OF THE INVENTION

A first aspect of the invention provides a chop and catch apparatus comprising (I) a base comprising a base lower member and a base frame member surrounding and bounding base lower member and extending vertically upward therefrom forming an uncovered internal cavity; (II) a support member comprising a spine and a plurality of support member arms, such support member freely removable from the base and positioned in the cavity of the base and secured to the base during use; (III) a plurality of trays, each tray freely removable from the base, wherein the plurality of trays are positioned in the cavity of the base during use and at least one tray is positioned on one side of the support member and at least one tray is positioned on the opposite side of the support member; and (IV) a cutting board comprising a cutting board center member and a plurality of cutting board arms extending from cutting board center member, such cutting board being removably secured to the base and positioned above the cavity of the base, the plurality of trays, and the support member during such use.

A second aspect of the invention provides a chop and catch apparatus comprising a (1) base comprising a base lower member and a base frame member surrounding and bounding base lower member and extending vertically upward therefrom forming an uncovered internal cavity in the base, wherein the base frame member comprises an inner face oriented toward the center of the base lower member and an outer face oriented away from the center of the base lower member, and the inner and outer faces of the base frame member are spaced-apart and separated by structure extending therebetween so as to form a base frame upper lip, and further wherein formed on the inner face of the base frame member is a plurality of notches and formed on the frame upper lip are a plurality of frame upper lip indentations, each such frame upper lip indentation positioned above one of the plurality of notches; (II) a support member comprising a spine and a plurality of support member arms, such support member freely removable from the base and positioned in the cavity of the base and secured to the base during use, wherein he spine comprises an anterior end and a posterior end and a first side and a second side, with the first side oriented toward a first direction and the second side oriented toward a second direction opposite and at 180 degrees from the first direction; and each of the plurality of support member arms comprises a first end attached to the spine and a second end distal from the spine, with the distal end of each of the plurality of support member arms secured in one of the plurality of the notches of the base frame member when the support member is positioned for use; (III) a plurality of trays, each tray freely removable from the base, wherein the plurality of trays are positioned in the cavity of the base during use and at least one tray is positioned proximal the first side of the support member and at least one tray is positioned proximal the second side of the support member; and (IV) a cutting board comprising a cutting board center member and a plurality of cutting board arms extending from cutting board center member, such cutting board positioned above the cavity of the base, the plurality of trays, and the support member during use, wherein each of the plurality of cutting board arms comprises a first end extending from the cutting board center member and a second end distal from the cutting board center member, with the distal end of each of the plurality of cutting board arms shaped similarly to each of the plurality of frame upper lip indentations, and the cutting board is removably secured to the base by the positioning of the distal end of each of the plurality of cutting board arms in one of the plurality of frame upper lip indentations.

A third aspect of the invention provides a chop and catch apparatus that is substantially quadrilateral-shaped comprising (I) a base that is quadrilateral-shaped comprising a base lower member that is quadrilateral-shaped with a quadrilateral perimeter and a base frame member attached to the perimeter of the base lower member, wherein the base frame member comprises four base frame lateral members and is quadrilateral-shaped and surrounds and bounds the base lower member and extends vertically upward from the perimeter of the base lower member forming an uncovered internal cavity in the base; each base frame lateral member is joined to two of the remaining four base frame lateral members, with the junction of each base frame lateral member to another base frame lateral member forming one of a total of four corners of the base frame member; each of the four base frame lateral members comprises an inner face oriented toward the center of the base lower member and an outer face oriented away from the center of the base lower member and separated and spaced-apart from the inner face by structure extending therebetween so as to form a base frame upper lip, and formed on the inner face of the base frame member is a plurality of notches and formed on the frame upper lip is a plurality of frame upper lip indentations, and the plurality of notches comprising four notches with one notch formed at each of the four corners of the base frame member, the plurality of frame upper lip indentations comprising four frame upper lip indentations with one each of the four frame upper lip indentations positioned at one of the four corners of the base frame member above one of the four notches; (II) a support member comprising a spine and a plurality of support member arms comprising a first end attached to the spine and a second end distal from the spine, such support member freely removable from the base and positioned in the cavity of the base and secured to the base during use, wherein the spine comprises an anterior end and a posterior end and a first side and a second side, with the first side oriented toward a first direction and the second side oriented toward a second direction opposite and at 180 degrees from the first direction and wherein each of the first and second sides are substantially perpendicular with each of the anterior and posterior ends of the spine; and the plurality of support member arms comprises four support member arms comprising (i) a first and a second anterior support member arm, each such anterior support member arm branching off of the anterior end of the spine and (ii) a first and a second posterior support member arm, each such posterior support member arm branching off of the posterior end of the spine, and wherein the distal end of each of the four support member arms is secured in one of the four notches of the base frame member when the support member is positioned for use; (III) a plurality of trays comprising a first tray and a second tray, each tray freely removable from the base and positioned in the cavity of the base during use and wherein (i) the first tray is positioned proximal the first side of the spine of the support member, the first anterior support member arm, and the first posterior support member arm, and (ii) the second tray is positioned proximal the second side of the spine of the support member, the second anterior support member arm, and the second posterior support member arm; and (IV) a cutting board that is quadrilateral-shaped comprising a cutting board center member that is quadrilateral-shaped with four corners and a plurality of cutting board arms comprising four cutting board arms with one of each of the cutting board arms extending from one of the four corners of the cutting board center member, wherein the cutting board is positioned above the cavity of the base, the plurality of trays, and the support member during use and each of the plurality of cutting board arms comprises a first end extending from the cutting board center member and a second end distal from the cutting board center member, with the distal end of each of the plurality of cutting board arms shaped similarly to the each of the plurality of frame upper lip indentations, and the cutting board is removably secured to the base by the positioning of the distal end of each of the plurality of cutting board arms in each of the plurality of frame upper lip indentations.

A fourth aspect of the invention provides a chop and catch apparatus comprising (I) a base comprising a base lower member and a base frame member surrounding and bounding base lower member and extending vertically upward therefrom forming an uncovered internal cavity; (II) a support member comprising a spine and a plurality of support member arms, such support member freely removable from the base and positioned in the cavity of the base during use and secured to the base during use; (III) a plurality of trays, each tray freely removable from the base, wherein the plurality of trays are positioned in the cavity of the base during use; and (IV) a cutting board comprising a cutting board center member and a plurality of cutting board arms extending from cutting board center member, such cutting board being removably secured to the base and positioned above the cavity of the base, the plurality of trays, and the support member during such use.

Further additional, advantageous aspects of the invention, such as variants of the aspects of the invention disclosed above, will become apparent to those of ordinary skill in the art upon review of the following description of the embodiments of the invention and the claims and with reference to the accompanying drawings.

By way of example only, specific embodiments of the invention will now be described, with reference to the accompanying drawings, in which:

### DESCRIPTION OF THE DRAWINGS

An embodiment of the invention is now described by way of example and with reference to the accompanying drawings:

FIG. 1 is a perspective view of an embodiment of the present invention;

FIG. 2 is a perspective view of the base according to an embodiment of the present invention;

FIG. 3 is a perspective view of the support member according to an embodiment of the present invention;

FIG. 4 is a perspective view of one of the plurality of trays according to an embodiment of the present invention;

FIG. 5 is a perspective view of the cutting board according to an embodiment of the present invention;

FIG. 6 is a detailed perspective view of one of the four corners of the base according to an embodiment of the present invention;

FIG. 7 is a perspective view of the base, support member, and plurality of trays according to an embodiment of the present invention;

FIG. 8 is a detailed perspective view of one of the four corners of the base with the support member positioned in place for use according to an embodiment of the present invention; and

FIG. 9 is a detailed perspective partial cutaway view of one of the four corners of the base with the support member, one of the plurality of trays, and the cutting board positioned in place for use according to an embodiment of the present invention.

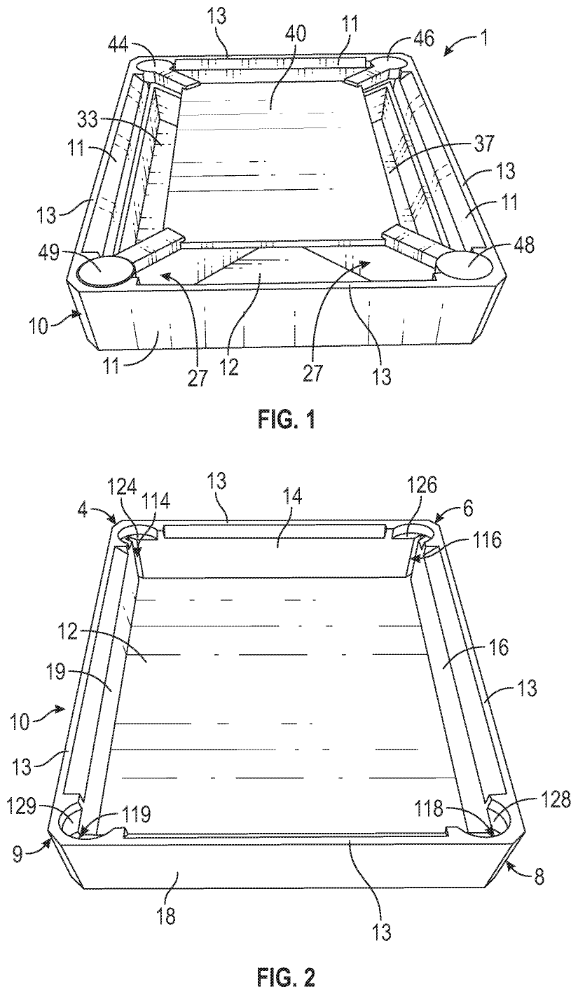

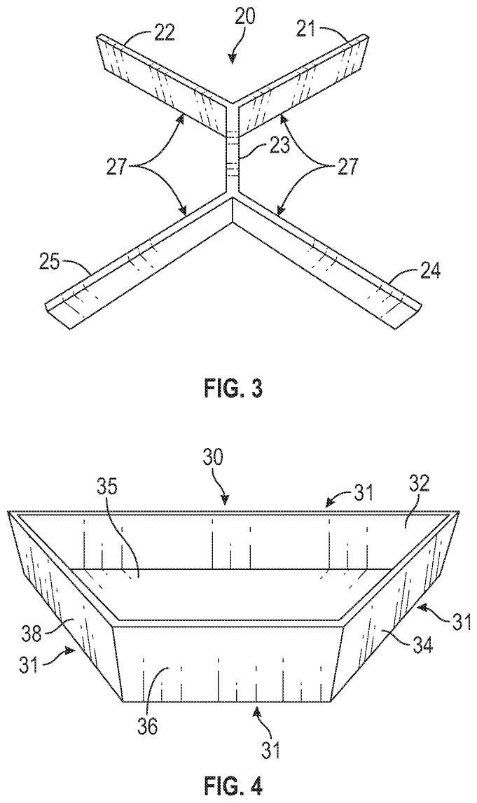

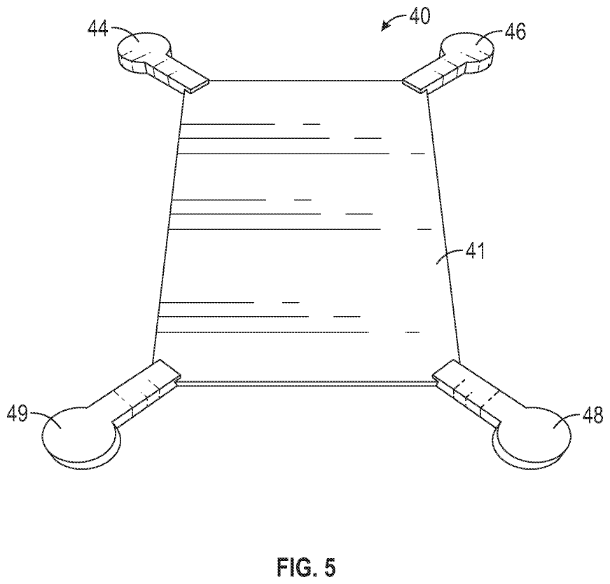

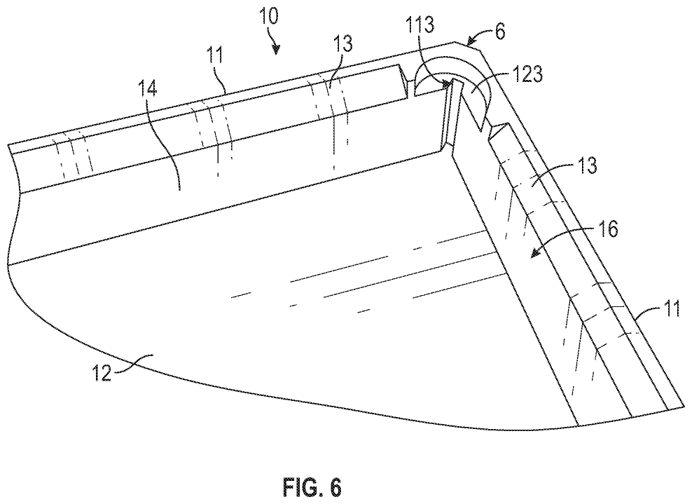

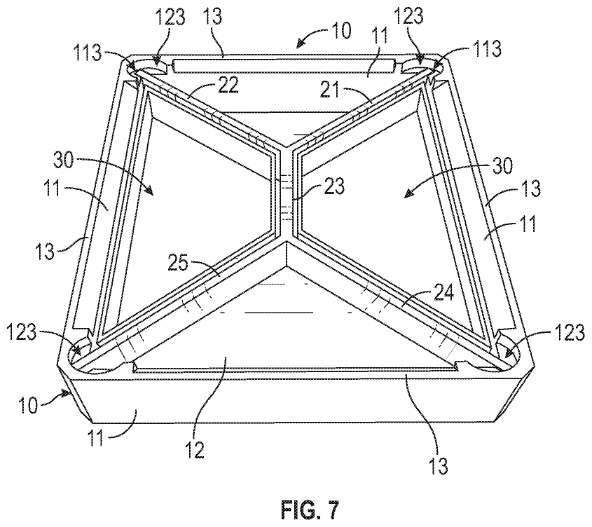

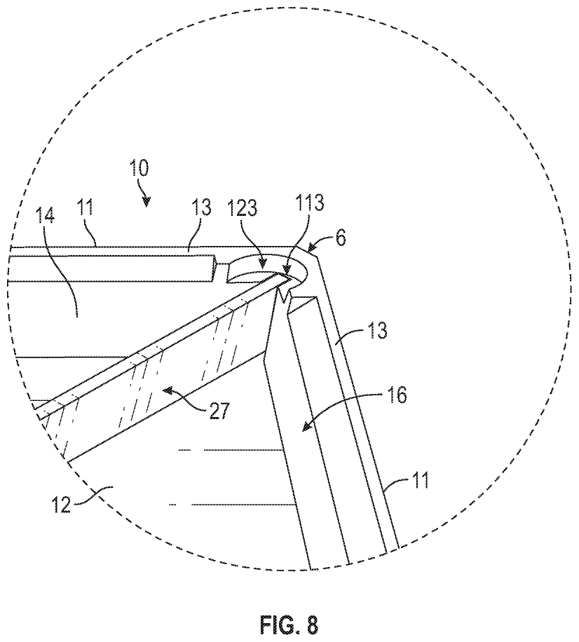

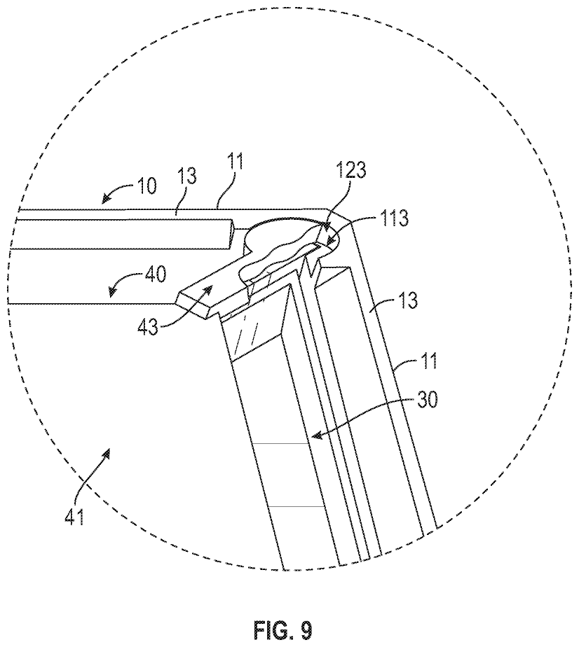

### DETAILED DESCRIPTION OF THE PREFERRED EMBODIMENTS

Chop and Catch Apparatus:

With reference to the above-described figures, chop and catch apparatus 1 comprises (i) base 10 comprising base lower member 12 and base frame member 11 positioned at the perimeter of base lower member 12 and extending vertically upward therefrom, such base frame member 11 surrounding and bounding base lower member 12 forming an uncovered internal cavity in base 10; (ii) support member 20 comprising spine 23 and plurality of support member arms 27, such support member 20 being freely removable from base 10 and positioned in the cavity of base 10 during use of chop and catch apparatus 1; (iii) plurality of trays 30, each tray 30 freely removable from base 10, with at least one tray 30 positioned on one side of support member 20 in the cavity of base 10 and at least one tray 30 positioned on the opposite side of support member 20 in the cavity of base 10 during use of chop and catch apparatus 1; and (iv) cutting board 40 comprising cutting board center member 41 and plurality of cutting board arms 43 extending from cutting board center member 41, such cutting board 40 being freely removable from base 10 and, during use of chop and catch apparatus 1, being removably secured to base 10 and positioned above the cavity of base 10 and the plurality of trays 30 and support member 20 therein. Preferably, each of base 10, support member 20, plurality of trays 30, and cutting board 40 are made from a material that is dishwasher-safe, such as aluminum, glass, plastic, and stainless steel. Alternatively, one or more of base 10, support member 20, plurality of trays 30, and cutting board 40 is made of a non-dishwasher safe material, such as wood and cast iron, and washable by hand. Preferably, each of base 10, support member 20, plurality of trays 30, and cutting board 40 is sized to be easily accommodated inside domestic dishwashing machines.

Base:

With references to the above-described figures, chop and catch apparatus 1 comprises base 10 comprising base lower member 12 and base frame member 11 positioned at the perimeter of base lower member 12 and extending vertically upward therefrom, such base frame member 11 surrounding and bounding base lower member 12 forming an uncovered internal cavity in base 10. In a preferred embodiment, base frame member 11 is quadrilateral-shaped and comprised of plurality of base frame lateral members 14, 16, 18, 19 positioned at the perimeter of base lower member 12.

In a preferred embodiment, base lower member 12 is substantially flat. Base lower member 12 can be formed from one unitary structure or a plurality of unitary structures joined together to form an integrated structure. Base frame member 11 is positioned to form a continuous structure bounding the perimeter of base lower member 12. Base frame member 11 can be formed from one unitary structure or a plurality of unitary structures joined together to form an integrated structure.

Base lower member 12 can be one of many different shapes, including oval, triangular, circular, trapezoidal, or quadrilateral (such as rectangular or square shape). Where base lower member 12 is circular or oval giving base 10 a substantially circular or oval shape, base frame member 11 is substantially curved in shape to accommodate the round shape of base lower member 12. Where base lower member 12 is formed of a shape with straight edges giving base 10 a triangular, trapezoidal, or quadrilateral shape, base frame member 11 is substantially straight-edged in shape to accommodate the base lower member 12 shape. In preferred embodiments where base frame member 11 is substantially straight-edged and quadrilateral-shaped, base frame member 11 comprises plurality of base frame lateral members 14, 16, 18, and 19 and each of the base frame lateral members 14, 16, 18, 19 is substantially straight-edged.

Base frame member 11 comprises an inner face oriented toward the center of base lower member 12 and an outer face oriented away from the center of base lower member 12. The inner and outer faces of base frame member 11 are spaced-apart by structure extending therebetween so as to form frame upper lip 13 of base frame member 11, such frame upper lip 13 substantially oriented upward and positioned at the highest vertical position of base frame member 11. Preferably, frame upper lip 13 is beveled so as to angle inwardly toward the center of base 10, more preferably, the outer portion of frame upper lip 13 is substantially flat and the inner position is beveled inwardly toward the center of base 10.

In preferred embodiments where base frame member 11 comprises plurality of base frame lateral members 14, 16, 18, 19, each of the base frame lateral members comprises an inner face oriented toward the center of base lower member 12 and an outer face oriented away from the center of base lower member 12. More preferably, the inner and outer faces of each base frame lateral member 11 are spaced-apart by structure extending therebetween forming frame upper lip 13. The one or more base frame lateral members 14, 16, 18, 19 are positioned to form a continuous structure bounding the perimeter of base lower member 12. Plurality of base frame lateral members 14, 16, 18, 19 can be formed from one unitary structure or a plurality of unitary structures joined together to form an integrated structure. In embodiments of chop and catch apparatus 1 wherein base 10 comprises base lower member 12 and base frame 11 comprising plurality of base frame lateral members 14, 16, 18, 19, the one or more base frame lateral members 14, 16, 18, 19 are joined together to form a continuous structure bounding the perimeter of base lower member 12. In such embodiments, the plurality of base frame lateral members 14, 16, 18, 19 of base frame 11 can be formed from one unitary structure shaped to form distinct segments comprising the plurality of base frame lateral members 14, 16, 18, 19 or a plurality of unitary structures, each corresponding to one of the plurality of base frame lateral members, joined together to form an integrated structure.

In a preferred embodiment of chop and catch apparatus 1, base 10 is substantially quadrilateral-shaped, comprising base lower member 12, more preferably formed from one unitary structure and substantially rectangular with four straight ends, and base frame member 11 comprising four base frame lateral members 14, 16, 18, 19, each base frame lateral member positioned at one of the four straight ends of the perimeter of base lower member 12, with base frame member 11 surrounding and bounding base lower member 12 and extending vertically upward therefrom. Each of the plurality of base frame lateral members 14, 16, 18, 19 is straight. The plurality of base frame lateral members 14, 16, 18, 19 of base frame member 11 are joined together at one of a plurality of corners of base frame member 11 to form an integrated structure, with first base frame lateral member 14 joined to second base frame lateral member 16 at first corner 6 of base frame member 11, second base frame lateral member 16 joined to third base frame lateral member 18 at second corner 8 of base frame member 11, third base frame lateral member 18 joined to fourth base frame lateral member 19 at third corner 9 of base frame member 11, and fourth base frame lateral member 19 joined to first base frame lateral member 14 at fourth corner 4 of base frame member 11.

With reference to the above-described figures, formed on the inner face of base frame member 11 of base 10 is a plurality of notches 113. Preferably, each of the plurality of notches 113 comprises a straight-edged void space formed into the structure between the inner and outer faces of base frame member 11. In a preferred embodiment wherein base 10 is substantially quadrilateral-shaped, base 10 comprises base lower member 12 and base frame member 11 comprising a plurality of base frame lateral members 14, 16, 18, 19. Formed on the inner face of base frame member 11 are plurality of notches 113 comprising first notch 114, second notch 116, third notch 118, and fourth notch 119 wherein first notch 116 is formed on the inner face of base frame member 11 at the juncture of first base frame lateral member 14 and second base frame lateral member 16 at first corner 6 of base frame member 11; second notch 118 is formed on the inner face of base frame member 11 at the juncture of second base frame lateral member 16 and third base frame lateral member 18 at second corner 8 of base frame member 11; third notch 119 is formed on the inner face of base frame member 11 at the juncture of third base frame lateral member 18 and fourth base frame lateral member 19 at third corner 9 of base frame member 11; and fourth notch 114 is formed on the inner face of base frame member 11 at the juncture of fourth base frame lateral member 19 and first base frame lateral member 14 at fourth corner 4 of base frame member 11.

With reference to the above-described figures, formed on frame upper lip 13 are plurality of frame upper lip indentations 123, each such frame upper lip indentation 123 positioned above one of the plurality of notches 113. Preferably, each of the plurality of indentations 123 comprises a semicircular void space formed into the structure of frame upper lip 13. In a preferred embodiment wherein base 10 is substantially quadrilateral-shaped, formed on frame upper lip 13 are plurality of frame upper lip indentations 123 comprising first frame upper lip indentation 126 formed on frame upper lip 13 at first corner 6 above first notch 116, second frame upper lip indentation 128 formed on frame upper lip 13 at second corner 8 above second notch 118, third frame upper lip indentation 129 formed on frame upper lip 13 at third corner 9 above third notch 119, and fourth frame upper lip indentation 124 formed on frame upper lip 13 at fourth corner 4 above forth notch 124.

Support Member:

With reference to the above-described figures, chop and catch apparatus 1 comprises support member 20. Support member 20 is a freely removable structure from base 10 that is positioned in the cavity of base 10 during use of chop and catch apparatus 1. Support member 20 can be formed from one unitary structure or a plurality of unitary structures joined together to form an integrated structure.

Support member 20 is used to provide vertical support to and maintain the stability of cutting board 40 during chop and catch apparatus 1 use to prevent cutting board 40 from descending or tipping into the cavity of base 10, with the upper surfaces of support member 20 preferably abutting the underside of cutting board 40 when both are positioned for use of chop and catch apparatus 1. Support member 20 is also used to segregate each of the plurality of trays 30 from each other so as to position each of the plurality of trays 30 in distinct positions in the cavity of base 10. Support member 20 is sized to provide vertical support for cutting board 40 over substantially the entire surface area of base lower member 12 of base 10.

Support member 20 comprises (i) spine 23 comprising an anterior end and a posterior end and a first side and a second side, with the first side oriented toward a first direction and the second side oriented toward a second direction opposite and at 180 degrees from the first direction; and (ii) one or more support member arms 27 branching off of the anterior end of spine 23, and one or more support member arms 27 branching off of the posterior end of spine 23. Each support member arm 27 comprises a first end joined to spine 23 and a second end distal from spine 23, with the distal end of each of the one or more support member arms 27 secured in one of the plurality of notches 113 of base frame member 11 of base 10 when support member 20 is positioned for use of chop and catch apparatus 1. The securing of each of the distal ends of the plurality of support member arms 27 in one of the plurality of notches 113 of base frame member 11 of base 10 prevents the dislodging or slippage of support member 20 from base 10 during chop and catch apparatus 1 use which would compromise the stability of cutting board 40 resulting from the vertical support of cutting board 40 provided by support member 20.

In a preferred embodiment, support member 20 comprises (i) spine 23 with an anterior end and a posterior end and a first side and a second side; and a plurality of support member arms 27 comprising (ii) first anterior support member arm 21 and second anterior support member arm 22, each joined to spine 23 at the anterior end of spine 23; and (iii) first posterior support member arm 24 and second posterior support member arm 25, each joined to spine 23 at the posterior end of spine 23. The distal ends of each of the plurality of support member arms 27 are proximal and adjacent to the inner face of base frame member 11 of base 10, with each such distal end of each of the plurality of support member arms 27 sized to approximate the size of the notches 113 of base frame member 11 of base 10 so as to be secured in notches 113 when support member 20 is positioned for use of chop and catch apparatus 1.

In a preferred embodiment wherein base 10 is substantially quadrilateral-shaped, plurality of support member arms 27 comprises support member arms 21, 22, 25, and 24 and the distal ends of such support member arms 27 are proximal and adjacent to the inner face of base frame member 11 of base 10 and secured into notches 116, 114, 119, and 118, respectively, during use of chop and catch apparatus 1. The securing of the distal ends of the arms 21, 22, 25, and 24 of support member 20 in notches 116, 114, 119, and 118, respectively prevents the dislodging or slippage of support member 20 from base 10 during chop and catch apparatus 1 use which would compromise the stability of cutting board 40 resulting from the vertical support of cutting board 40 provided by support member 20.

Plurality of Trays:

With reference to the above-described figures, chop and catch apparatus 1 comprises a plurality of trays 30, each tray 30 comprising tray lower member 35 and tray frame member 31 positioned at the perimeter of tray lower member 35 and extending vertically upward therefrom, with tray frame member 31 surrounding and bounding tray lower member 35 forming an uncovered internal cavity in tray 30. Each of the plurality of trays 30 is a freely removable structure from base 10 and support member 20 and is positioned in the cavity of base 10 during use of chop and catch apparatus 1. Tray lower member 35 can be formed from one unitary structure or a plurality of unitary structures joined together to form an integrated structure. Tray perimeter frame member 31 is positioned to form a continuous structure bounding the perimeter of tray lower member 35 and can be formed from one unitary structure or a plurality of unitary structures joined together to form an integrated structure.

The plurality of trays 30 is used to segregate and collect items that are chopped, cut, or otherwise manipulated on cutting board 40 during use of the chop and catch apparatus 1. The use of plurality of trays 30 compartmentalizes base 10, allowing for the volume of the internal cavity of base 10 to be segregated into a plurality of compartments (the plurality of trays 30 and, in preferred embodiments, portions of the internal cavity of base 10 external the trays 30) for the segregation of various items chopped, cut, or otherwise manipulated on cutting board 40 of chop and catch apparatus 1 to allow for the segregated collection of such items after manipulation, cutting, or chopping. During use of chop and catch apparatus 1, each of plurality of trays 30 is positioned under cutting board 40 with at least a portion of the uncovered cavity of each such tray 30 exposed so that the user can easily move manipulated/cut/chopped items from cutting board 40 into each such tray 30. As such, each of the plurality of trays 30 can be used to collect one of multiple items that are chopped, cut, or otherwise manipulated on cutting board 40 during use of chop and catch apparatus 1 when more than one such item is chopped, cut, or otherwise manipulated, which allows for the segregated collection of the manipulated/cut/chopped items.

Preferably, plurality of trays 30 are sized so that the aggregation of the cross sectional area of each of the plurality of trays 30, comprising the aggregation of the surface area of each tray lower member 35, comprises a substantial portion of the surface area of base lower member 12 of base 10. Moreover and preferably, the vertical height of tray frame member 31 approximates the vertical height of base frame member 11 of base 10, more preferably having the same such vertical height. Alternatively, the vertical height of tray frame member 31 is slightly less than the vertical height of base frame member 11 of base 10.

When positioned in the internal cavity of base 10 during use of chop and catch apparatus 1 wherein support member 20 is also positioned therein, each of the plurality of trays 30 is positioned to a side of support member 20, and each of the plurality of trays 30 is surrounded and bound by support member 20 and base frame member 11 of base 10, with tray frame member 31 positioned proximal and adjacent to one or more of support member 20 spine 23 and support member aims 27 and base frame member 11 of base 10. This positioning of the plurality of trays 30 maintains each of the trays 30 secured in position to prevent displacement of each tray 30 so that the exposed portion of the uncovered internal cavity of each such tray 30 remains exposed during chop and catch apparatus 1 use to allow for continual, uninterrupted collection of manipulated, cut, or chopped items without having to remove cutting board 40 and reposition such tray 30.

In a preferred embodiment wherein base 10 is quadrilateral-shaped and base frame member 11 is comprised of plurality of base frame lateral members 14, 16, 18, 19, plurality of trays 30 comprises two trays 33 and 37. Tray frame member 31 of each tray 30 is positioned proximal and adjacent to support member 20 spine 23, one or more support member arms 21, 22, 24, and 25, and one or more base frame lateral members 14, 16, 18, 19 of base frame member 11 of base 10. First tray 33 is positioned adjacent to and proximal to the first side of spine 23 of support member 20 and second tray 37 is positioned adjacent to and proximal to the second side of spine 23.

The plurality of trays 30 can be one of many different shapes, including oval, triangular, circular, trapezoidal, or that of a parallelogram or quadrilateral (rectangular or square shape). In a preferred embodiment, each of the plurality of trays 30 is the same shape. Additionally, and in a preferred embodiment, each of the plurality of trays 30 is trapezoidal shaped (as shown in FIG. 4), with tray 30 comprised of (i) tray lower member 35 with four ends defining a perimeter; and (ii) tray frame member 31 comprising first tray base 32 and second tray base 36 (the bases being the opposite sides of tray 30 that are parallel to each other), and first tray leg 34 and second tray leg 38 (the legs being the remaining sides of tray 30 that intersect at some point if extended), each of tray bases 32 and 36 and tray legs 34 and 38 positioned at and extending vertically upward from one of the four ends of the perimeter of tray lower member 35.

Cutting Board:

With reference to the above-described figures, chop and catch apparatus 1 comprises cutting board 40 for a user to manipulate, chop, or cut items during use of chop and catch apparatus 1. Cutting board 40 is a freely removable structure from base 10, support member 20, and the plurality of trays 30. Cutting board 40 comprises (i) cutting board center member 41 that is substantially flat and has substantially the same shape as base 10, wherein such cutting board center member 41 covers substantially most, but not all, of the uncovered internal cavity of base 10; and (ii) plurality of cutting board arms 43 extending from cutting board center member 41, wherein each of the plurality of cutting board arms 43 is spaced apart from the remaining plurality of cutting board arms 43. Each of the plurality of cutting board arms 43 comprises first end joined to cutting board center member 41 and second end distal from cutting board center member 41, with the distal end of each of the plurality of cutting board arms 43 shaped similarly to the each of the plurality of frame upper lip indentations 123 so as to allow for the distal end of each of the plurality of cutting board arms 43 to be positioned in one of the plurality of frame upper lip indentations 123 to removably secure cutting board 40 to base 10 during use of chop and catch apparatus 1 to prevent substantial sliding or lateral or longitudinal displacement of cutting board 40 during use.

Cutting board 40 can be formed from one unitary structure or a plurality of unitary structures joined together to form an integrated structure. Alternatively, and in a preferred embodiment, cutting board center member 41 is formed from one unitary structure with each of the plurality of cutting board arms 43 formed from one unitary structure attached to cutting board center member 41. Moreover, and in a preferred embodiment, cutting board center member 41 and plurality of cutting board arms 43 are formed from one unitary structure. Further, and in a preferred embodiment, one or more of the plurality of cutting board arms 43 is separable from and attachable to cutting board center member 41, such attachment accomplished using one or more attachment devices known in the art such as clips or screws. Preferably, one or more cutting board arms 43 is separable from and attachable to cutting board center member 41 and, for each such cutting board arm 43, first attachment device is positioned on first end of each cutting board arm which is proximal cutting board center member 41 and second attachment device is positioned at the portion of the perimeter of the cutting board center member 41 proximal the first end of each cutting board arm 43 and can mate with first attachment device. In a more preferred embodiment, a plurality of hollow channels are formed into the structure of the cutting board center member 41 and one or more of the plurality of cutting board arms 43 is attached to cutting board center member 41 by inserting the first end of each such cutting board arm 43, which is proximal to cutting board center member 41, into one of the plurality of hollow channels and securing the first end of each such cutting board arm 43 therein.

In a preferred embodiment of chop and catch apparatus 1 comprising a substantially quadrilateral-shaped base 10, cutting board 40 comprises substantially quadrilateral-shaped cutting board center member 41 with four corners and plurality of cutting board arms 43 comprising one of each of the plurality of cutting board arms 43 at one of the four corners of cutting board center member 41. The plurality of cutting board arms 43 comprises first cutting board arm 46 that is positioned in first frame upper lip indentation 126 during chop and catch apparatus 1 use, second cutting board arm 48 that is positioned in second frame upper lip indentation 128 during chop and catch apparatus 1 use, third cutting board arm 49 that is positioned in third frame upper lip indentation 129 during chop and catch apparatus 1 use, and fourth cutting board arm 44 that is positioned in fourth frame upper lip indentation 124 during chop and catch apparatus 1 use. More preferably, the distal end of each the plurality of cutting board arms 43 (cutting board arms 44, 46, 48, 49) is substantially circular and is positioned in one of the plurality of frame upper lip indentations 123 (frame upper lip indentations 124, 126, 128, 129, respectively), each of the plurality of frame upper lip indentations 123 comprising a substantially semicircular void space formed into the structure of frame upper lip 13. In an alternative embodiment wherein each of the plurality of cutting board arms 43 is separably attachable to cutting board center member 41, positioned at each of the four corners of cutting board center member 41 is an attachment device used to attach one of the plurality of cutting board arms 43 to cutting board center member 41 at a corner thereof. Alternatively, a plurality of hollow channels are formed into the structure of the cutting board center member 41 with one such hollow channel formed at each of the four corners of cutting board center member 41 and each of the plurality of cutting board arms 43 is attached to cutting board center member 41 by inserting the first end of each such cutting board arm 43, which is proximal to cutting board center member 41, into one of the hollow channels positioned at each of the four corners of cutting board center member 41 and securing the first end of each such cutting board arm 43 therein.

Cutting board 40 is positioned above base 10, support member 20, and plurality of trays 30 during use of chop and catch apparatus 1, with support member 20 and plurality of trays 30 positioned in the uncovered internal cavity of base 10. Preferably, cutting board 40 is smaller in cross sectional area than base 10. More preferably, cutting board 40 covers substantially most, but not all, of the uncovered internal cavity of base 10, leaving exposed one or more portions of such cavity of base 10. The partial coverage of the uncovered internal cavity of base 10 provided by cutting board 40 when cutting board 40 is positioned above base 10 during chop and catch apparatus 1 use allows for the user to easily move manipulated/cut/chopped items from cutting board 40 into the plurality of trays 30 without having to remove cutting board 40 from its position above base 10. In a preferred embodiment wherein base 10 is quadrilateral-shaped and base frame 11 is comprised of plurality of base frame lateral members 14, 16, 18, 19, cutting board 40 is smaller in cross sectional area than base 10, with approximately one to two inches extending between each of the plurality of base frame lateral members 14, 16, 18, 19 and one of the four ends of the perimeter of quadrilateral-shaped cutting board center member 41 when cutting board 40 is positioned above base 10 during use of chop and catch apparatus 1.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

I claim:

1. A chop and catch apparatus comprising:
a. a base comprising a base lower member and a base frame member surrounding and bounding base lower member and extending vertically upward therefrom forming an uncovered internal cavity in the base;
b. a support member comprising a spine and a plurality of support member arms, each attached to the spine, such support member freely removable from the base and positioned in the cavity of the base and secured to the base during use;
c. a plurality of trays, each tray freely removable from the base, wherein the plurality of trays are positioned in the cavity of the base during use and at least one tray is positioned on one side of the support member and at least one tray is positioned on the opposite side of the support member; and
d. a cutting board comprising a cutting board center member and a plurality of cutting board arms extending from cutting board center member, such cutting board being removably secured to the base and positioned above the cavity of the base, the plurality of trays, and the support member during such use.

2. A chop and catch apparatus as claimed in claim 1, further comprising one or more attachment devices and wherein one or more of the plurality of cutting board arms is separable from and attachable to the cutting board center member, and wherein each of the one or more separable cutting board arms is attached to the cutting board center member using one or more attachment devices.

3. A chop and catch apparatus as claimed in claim 1, wherein:
a. the base frame member comprises an inner face oriented toward the center of the base lower member and an outer face oriented away from the center of the base lower member, wherein the inner and outer faces of the base frame member are spaced-apart and separated by structure extending therebetween so as to form a base frame upper lip, and wherein formed on the inner face of the base frame member is a plurality of notches; and wherein formed on the frame upper lip are a plurality of frame upper lip indentations, each such frame upper lip indentation positioned above one of the plurality of notches;
b. the spine of the support member comprises an anterior end and a posterior end and a first side and a second side, with the first side oriented toward a first direction and the second side oriented toward a second direction opposite and at 180 degrees from the first direction, and each of the plurality of support member arms comprises a first end attached to the spine and a second end distal from the spine, with the distal end of each of the plurality of support member arms secured in one of the plurality of the notches of the base frame member when support member is positioned for use; and
c. each of the plurality of cutting board arms comprises a first end extending from the cutting board center member and a second end distal from the cutting board center member, with the distal end of each of the plurality of cutting board arms shaped similarly to the each of the plurality of frame upper lip indentations, and the removable securing of the cutting board to the base comprises the positioning of the distal end of each of the plurality of cutting board arms in one of the plurality of frame upper lip indentations.

4. A chop and catch apparatus as claimed in claim 3, wherein:
a. Each of the base lower member and the base frame member is quadrilateral-shaped, with the base frame member comprised of four base frame lateral members and each of the base frame lateral members is joined to two of the remaining four base frame lateral members, with the junction of each base frame lateral member to another base frame lateral member forming one of a total of four corners of the base frame member;
b. a cutting board that is quadrilateral-shaped comprising a cutting board center member that is quadrilateral-shaped and a plurality of cutting board arms comprising four cutting board arms with one of each of the cutting board arms proximal one of the four corners of the base frame member; and
c. The plurality of notches comprises four notches with one notch positioned at each corner of the base frame member and the plurality of frame upper lip indentations comprises four upper lip indentations, with each of the upper lip indentations positioned above one of the notches.

5. A chop and catch apparatus as claimed in claim 1, wherein each of the base and cutting board comprises a structure with a shape selected from the group consisting of circular and oval; and each of the plurality of trays comprises a structure with a shape selected from the group consisting of semicircular or semi-oval.

6. A chop and catch apparatus comprising:
a. a base comprising a base lower member and a base frame member surrounding and bounding base lower member and extending vertically upward therefrom forming an uncovered internal cavity in the base, wherein:
i. the base frame member comprises an inner face oriented toward the center of the base lower member and an outer face oriented away from the center of the base lower member, and
ii. the inner and outer faces of the base frame member are spaced-apart and separated by structure extending therebetween so as to form a base frame upper lip, and further wherein formed on the inner face of the base frame member is a plurality of notches and formed on the frame upper lip are a plurality of frame upper lip indentations, each such frame upper lip indentation positioned above one of the plurality of notches;
b. a support member comprising a spine and a plurality of support member arms, such support member freely removable from the base and positioned in the cavity of the base and secured to the base during use, wherein
i. the spine comprises an anterior end and a posterior end and a first side and a second side, with the first side oriented toward a first direction and the second side oriented toward a second direction opposite and at 180 degrees from the first direction; and
ii. each of the plurality of support member arms comprises a first end attached to the spine and a second end distal from the spine, with the distal end of each of the plurality of support member arms secured in one of the plurality of the notches of the base frame member when the support member is positioned for use;
c. a plurality of trays, each tray freely removable from the base, wherein the plurality of trays are positioned in the cavity of the base during use and at least one tray is positioned proximal the first side of the support member and at least one tray is positioned proximal the second side of the support member; and
d. a cutting board comprising a cutting board center member and a plurality of cutting board arms extending from cutting board center member, such cutting board positioned above the cavity of the base, the plurality of trays, and the support member during use, wherein
i. each of the plurality of cutting board arms comprises a first end extending from the cutting board center member and a second end distal from the cutting board center member, with the distal end of each of the plurality of cutting board arms shaped similarly to each of the plurality of frame upper lip indentations, and
ii. the cutting board is removably secured to the base by the positioning of the distal end of each of the plurality of cutting board arms in one of the plurality of frame upper lip indentations.

7. A chop and catch apparatus as claimed in claim 6, further comprising one or more attachment devices and wherein one or more of the plurality of cutting board arms is separable from and attachable to the cutting board center member and wherein each of the one or more separable cutting board arms is attached to the cutting board center member using one or more attachment devices.

8. A chop and catch apparatus as claimed in claim 6, wherein the base frame upper lip comprises an outer portion and an inner portion and wherein the outer portion is substantially flat and the inner position is beveled inwardly toward the center of base.

9. A chop and catch apparatus as claimed in claim 6, wherein the second end of each cutting board arm is substantially circular and each frame upper lip indentation comprises a substantially semicircular void space formed into the structure of frame upper lip.

10. A chop and catch apparatus as claimed in claim 6, wherein each of the plurality of trays is trapezoidal-shaped.

11. A chop and catch apparatus that is substantially quadrilateral-shaped comprising:
a. a base that is quadrilateral-shaped comprising a base lower member that is quadrilateral-shaped with a quadrilateral perimeter and a base frame member attached to the perimeter of the base lower member, wherein
i. the base frame member comprises four base frame lateral members and is quadrilateral-shaped and surrounds and bounds the base lower member and extends vertically upward from the perimeter of the base lower member forming an uncovered internal cavity in the base;
ii. each base frame lateral member is joined to two of the remaining four base frame lateral members, with the junction of each base frame lateral member to another base frame lateral member forming one of a total of four corners of the base frame member;
iii. each of the four base frame lateral members comprises an inner face oriented toward the center of the base lower member and an outer face oriented away from the center of the base lower member and separated and spaced-apart from the inner face by structure extending therebetween so as to form a base frame upper lip, and
iv. formed on the inner face of the base frame member is a plurality of notches and formed on the frame upper lip is a plurality of frame upper lip indentations, and the plurality of notches comprising four notches with one notch formed at each of the four corners of the base frame member, the plurality of frame upper lip indentations comprising four frame upper lip indentations with one each of the four frame upper lip indentations positioned at one of the four corners of the base frame member above one of the four notches;
b. a support member comprising a spine and a plurality of support member anus comprising a first end attached to the spine and a second end distal from the spine, such support member freely removable from the base and positioned in the cavity of the base and secured to the base during use, wherein
i. the spine comprises an anterior end and a posterior end and a first side and a second side, with the first side oriented toward a first direction and the second side oriented toward a second direction opposite and at 180 degrees from the first direction and wherein each of the first and second sides are substantially perpendicular with each of the anterior and posterior ends of the spine; and
ii. the plurality of support member arms comprises four support member arms comprising (i) a first and a second anterior support member arm, each such anterior support member arm branching off of the anterior end of the spine and (ii) a first and a second posterior support member arm, each such posterior support member arm branching off of the posterior end of the spine, and wherein the distal end of each of the four support member arms is secured in one of the four notches of the base frame member when the support member is positioned for use;
c. a plurality of trays comprising a first tray and a second tray, each tray freely removable from the base and positioned in the cavity of the base during use and wherein (i) the first tray is positioned proximal the first side of the spine of the support member, the first anterior support member arm, and the first posterior support member arm, and (ii) the second tray is positioned proximal the second side of the spine of the support member, the second anterior support member arm, and the second posterior support member arm; and
d. a cutting board that is quadrilateral-shaped comprising a cutting board center member that is quadrilateral-shaped with four corners and a plurality of cutting board arms comprising four cutting board arms with one of each of the cutting board arms extending from one of the four corners of the cutting board center member, wherein
i. the cutting board is positioned above the cavity of the base, the plurality of trays, and the support member during use and
ii. each of the plurality of cutting board arms comprises a first end extending from the cutting board center member and a second end distal from the cutting board center member, with the distal end of each of the plurality of cutting board arms shaped similarly to the each of the plurality of frame upper lip indentations, and
iii. the cutting board is removably secured to the base by the positioning of the distal end of each of the plurality of cutting board arms in each of the plurality of frame upper lip indentations.

12. A chop and catch apparatus as claimed in claim 11, further comprising one or more attachment devices and wherein one or more of the plurality of cutting board arms is separable from and attachable to the cutting board center member and wherein each of the one or more separable cutting board arms is attached to the cutting board center member using one or more attachment devices.

13. A chop and catch apparatus as claimed in claim 11, wherein the base frame upper lip comprises an outer portion and an inner portion and wherein the outer portion is substantially flat and the inner position is beveled inwardly toward the center of base.

14. A chop and catch apparatus as claimed in claim 11, wherein the second end of each cutting board arm is substantially circular and each frame upper lip indentation comprises a substantially semicircular void space formed into the structure of frame upper lip.

15. A chop and catch apparatus as claimed in claim 11, wherein each of the plurality of trays is trapezoidal-shaped.

16. A chop and catch apparatus comprising:
a. a base comprising a base lower member and a base frame member surrounding and bounding base lower member and extending vertically upward therefrom forming an uncovered internal cavity;
b. a support member comprising a spine and a plurality of support member arms, such support member freely removable from the base and positioned in the cavity of the base during use and secured to the base during use;
c. a plurality of trays, each tray freely removable from the base, wherein the plurality of trays are positioned in the cavity of the base during use; and
d. a cutting board comprising a cutting board center member and a plurality of cutting board arms extending from cutting board center member, such cutting board being removably secured to the base and positioned above the cavity of the base, the plurality of trays, and the support member during such use.

17. A chop and catch apparatus as claimed in claim 16, further comprising one or more attachment devices and wherein one or more of the plurality of cutting board arms is separable from and attachable to the cutting board center member and wherein each of the one or more separable cutting board arms is attached to the cutting board center member using one or more attachment devices.

18. A chop and catch apparatus as claimed in claim 16, wherein the base frame upper lip comprises an outer portion and an inner portion and wherein the outer portion is substantially flat and the inner position is beveled inwardly toward the center of base.

19. A chop and catch apparatus as claimed in claim 16, wherein the second end of each cutting board arm is substantially circular and each frame upper lip indentation comprises a substantially semicircular void space formed into the structure of frame upper lip.

20. A chop and catch apparatus as claimed in claim 16, wherein each of the plurality of trays is trapezoidal-shaped.
